(19) United States
(12) Patent Application Publication
(10) Pub. No.: US 2013/0254240 A1
(43) Pub. Date: Sep. 26, 2013

(54) METHOD OF PROCESSING DATABASE, DATABASE PROCESSING APPARATUS, COMPUTER PROGRAM PRODUCT

(71) Applicants: Takahiro KURITA, Kanagawa (JP); Takao Marukame, Kanagawa (JP); Atsuhiro Kinoshita, Kanagawa (JP)

(72) Inventors: Takahiro KURITA, Kanagawa (JP); Takao Marukame, Kanagawa (JP); Atsuhiro Kinoshita, Kanagawa (JP)

(21) Appl. No.: 13/729,633

(22) Filed: Dec. 28, 2012

(30) Foreign Application Priority Data
Mar. 22, 2012 (JP) 2012-065045

(51) Int. Cl. G06F 17/30

(52) U.S. Cl. CPC G06F 17/30289
USPC 707/802

(57) ABSTRACT

According to an embodiment, a method of processing a database includes dividing a first data table that includes records including data in a plurality of columns into a plurality of second data tables based on a predetermined criterion for dividing columns. Each of the second data tables includes data in at least one column. The method also includes dividing each of the second data tables into a plurality of third data tables based on a predetermined criterion for dividing data in units of a record based on the data. Each of the third data tables includes at least one record. The method also includes storing the third data tables in a plurality of storage units, respectively. Each of the storage units allows the data to be read independently.

### CROSS-REFERENCE TO RELATED APPLICATION

This application is based upon and claims the benefit of priority from Japanese Patent Application No. 2012-065045, filed on Mar. 22, 2012; the entire contents of which are incorporated herein by reference.

### FIELD

Embodiments described herein relate generally to a method of processing a database, a database processing apparatus, and a computer program product.

### BACKGROUND

A database management system (DBMS) for a distributed system using a relational database maintains data by a unit of table, or maintains data described in XML format. The DBMS employs a management method to divide data tables, which are included in the database, in order to improve search efficiency. For example, a known technique divides a record by a value in a specific column to store each of the divided records in different servers or store a column that has a high degree of independence from other columns in a different server. Setting key ranges for multiple columns and allocating different data storage areas corresponding to key ranges reduce the amount of data to be accessed for search, thus enabling faster search of the database.

When a method of dividing the data table is preliminarily determined, statements that are actually used for search with high frequency are assumed, and a dividing method with high efficiency for the search is employed. In this case, a search that is not assumed does not lead to desired search efficiency.

### BRIEF DESCRIPTION OF THE DRAWINGS

FIG. 1A is a block diagram of a database processing apparatus according to an embodiment;

FIG. 1B is a block diagram of a storage unit of the database processing apparatus;

FIG. 1C is a block diagram of an interface unit of the database processing apparatus;

FIGS. 2A to 2C are exemplary diagrams illustrating a procedure to divide a data table in accordance with the embodiment;

FIG. 3 is a table configuration illustrating a record master table according to the embodiment;

FIG. 4 is a table configuration illustrating a division information table according to the embodiment;

FIG. 5 is a flowchart of a record inserting process according to the embodiment;

FIG. 6 is a flowchart of a record searching process according to the embodiment;

FIG. 7 is a flowchart of a record updating process according to the embodiment;

FIG. 8 is a flowchart of a record deleting process according to the embodiment; and

FIG. 9 is a flowchart of a record searching process according to the embodiment.

### DETAILED DESCRIPTION

According to an embodiment, a method of processing a database includes dividing a first data table that includes records including data in a plurality of columns into a plurality of second data tables based on a predetermined criterion for dividing columns. Each of the second data tables includes data in at least one column. The method also includes dividing each of the second data tables into a plurality of third data tables based on a predetermined criterion for dividing data in units of a record based on the data. Each of the third data tables includes at least one record. The method also includes storing the third data tables in a plurality of storage units, respectively. Each of the storage units allows the data to be read independently.

A database processing apparatus according to an embodiment of the present invention will be described in detail below by referring to the accompanying drawings. This embodiment describes an example of an application of a database processing apparatus that maintains a data table in a format of a relational database. However, an example of an application of a configuration where a relational database maintains data described in XML format or a similar configuration may alternatively be employed.

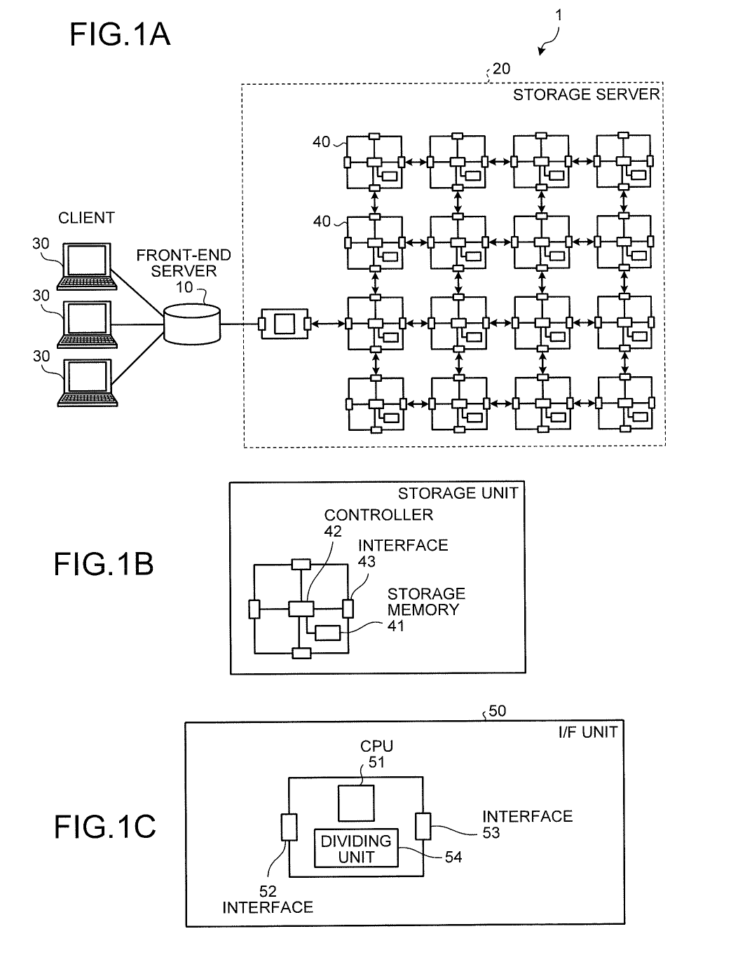

FIG. 1A is a block diagram illustrating an exemplary hardware configuration of a database processing apparatus 1 according to the embodiment. The database processing apparatus 1 includes a front-end server 10 and a storage server 20. The front-end server 10 receives a request from a client 30 and transfers the received request to the storage server 20. The front-end server 10 receives an insertion request, a search request, an update request, and a deletion request from the client 30 to the database. The front-end server 10 refers to contents of these requests to divide it according to ranges of columns and data. A more detailed description will be provided below.

The storage server 20 accesses a storage unit 40, which stores data. As illustrated in FIG. 1B, the storage unit 40 includes a storage memory 41, a controller 42, and an interface 43. The storage memory 41 is a part where data is physically stored. The storage memory 41 employs a hard disk drive (HDD), a solid state drive (SSD), a flash memory, a non-volatile memory such as an MRAM, or a similar medium. In this embodiment, the storage units 40 are storage areas, which are physically independent of one another. The controller 42 transmits and receives data from/to an adjacent storage unit 40. The controller 42 reads and writes data from/to the storage memory 41 independently from other storage units 40. In this embodiment, the storage units 40 are arranged in a square grid pattern. However, the physical arrangement of the embodiment may be changed appropriately as necessary.

An interface (I/F) unit 50 is disposed between the front-end server 10 and the storage server 20. As illustrated in FIG. 1C, the I/F unit 50 includes a CPU 51, an interface 52, an interface 53 and a dividing unit 54. The interface 52 inputs and outputs data from/to the front-end server 10. The interface 53 inputs and outputs data from/to the storage unit 40. The dividing unit 54 includes a logic circuit and a storage area where information used for dividing a data table is stored. The dividing unit 54 uses a method described below to divide data when executing a process for the storage unit 40 in accordance with a request received from the front-end server 10. The request includes a request to insert, update, and delete a record.

Alternatively, the I/F unit 50 or the front-end server 10 may divide data. In this embodiment, the front-end server 10 and the storage server 20 are configured in different hardware. However, the front-end server 10 and the storage server 20 may be configured in the same hardware.

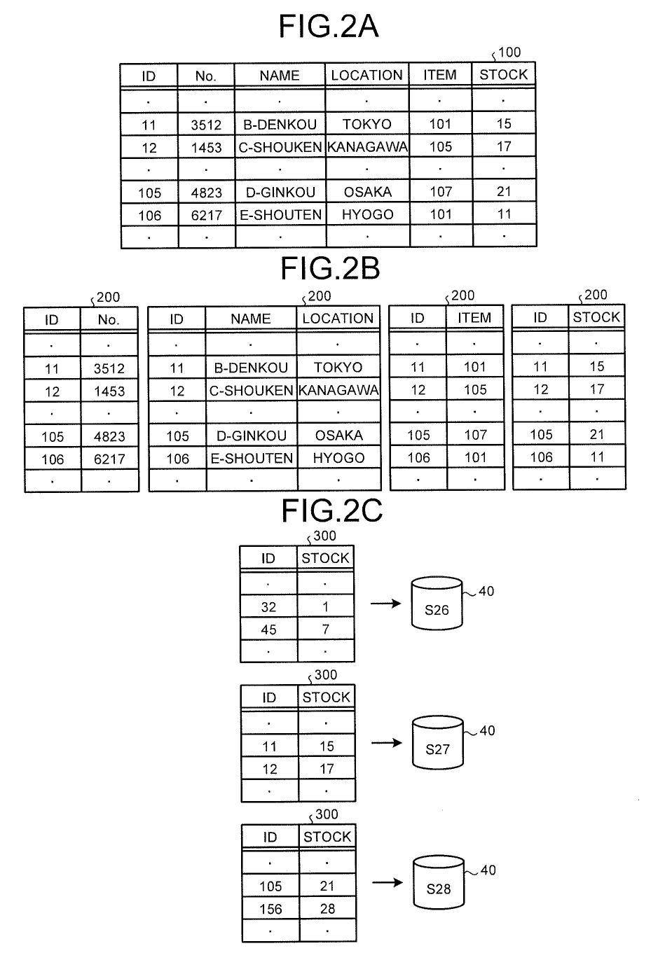

Next, a procedure to divide a database in accordance with this embodiment will be described by referring to FIGS. 2A to 2C. FIGS. 2A to 2C are exemplary diagrams illustrating a procedure to divide a data table by data in both an arbitrary record and a column. In practice, data is finally stored in the storage memory 41 of the storage unit 40 in a state illustrated in FIG. 2C. FIGS. 2A and 2B illustrate the state of a table before being divided for convenience of description.

As illustrated in FIG. 2A, a first data table 100 according to this embodiment includes the columns named “ID (identification information)”, “No.”, “Name”, “Location”, “Item”, and “Stock”. Four exemplary records, which have the respective IDs of 11, 12, 105, and 106, are illustrated.

First, the first data table 100 is divided to obtain second data tables 200 in accordance with a criterion for dividing columns. The criterion is defined by combinations of arbitrary columns. FIG. 2B illustrates the respective second data tables 200. As illustrated in FIG. 2B, the criterion for dividing columns is defined by combinations of “ID” and “No.”, “ID” and “Name” and “Location”, “ID” and “Item”, and “ID” and “Stock” in this embodiment. The first data table 100 is divided into the four second data tables 200 in accordance with this criterion for dividing columns. The criterion for dividing columns may be written in a program, or may be stored in the storage unit 40 as a table for setting. The four second data tables 200 are then divided to obtain third data tables 300. The four second data tables 200 are divided according to a value of data in a record. FIG. 2C illustrates states of the obtained third data tables 300. This figure illustrates only tables obtained with the combination of “ID” and “Stock”. Three other combinations also generate tables similarly.

As illustrated in FIG. 2C, the third data tables 300 are divided into three portions corresponding to respective three ranges of data values in the column “Stock”. The three ranges are “1 to 10”, “11 to 20”, and “21 or more”. The division based on ranges of values may be executed with other methods. The other methods may be based on size of data values in a column or hash values generated from data, or on other conditions. In FIG. 2C, three third data tables 300 are generated. The three generated third data tables 300 are stored in respective physically different storage units 40.

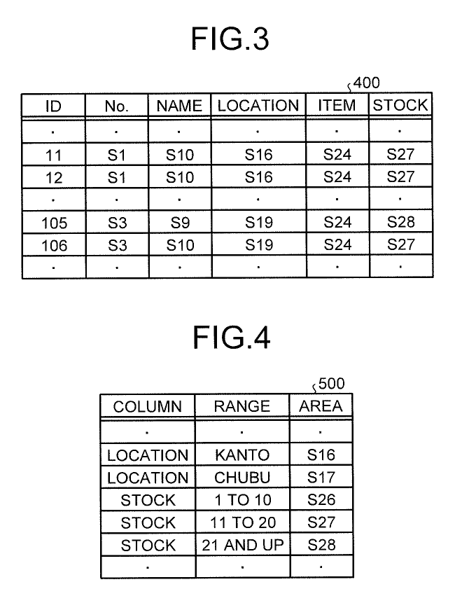

In this embodiment, the front-end server 10 stores a record master table and a division information table. FIG. 3 illustrates a record master table, and FIG. 4 illustrates a division information table. As illustrated in FIG. 3, a record master table 400 (a location information table) stores location information, which is associated with an ID, of the storage unit 40 where the data in each column is physically stored. The location information of the storage unit 40 is expressed in Si (i stands for an integer equal to or more than one). For example, in a record that has an ID of 11, “S1” as data of the column “No.”, “S10” as data of the column “Name”, “S16” as data of the column “Location”, “S24” as data of the column “Item”, and “S27” as data of the column “Stock” are stored. Accordingly, use of an ID as a key to search the record master table 400 allows obtaining the location where the data in each column is stored immediately. Location information of the storage unit 40 is not limited to information about physical hardware unit, but may also be a logical address in a disk, or similar information may be specified. The data structure of the record master table 400 is not limited to the structure illustrated in the figure.

As illustrated in FIG. 4, a division information table 500 stores location information of the storage unit 40 where the column is physically stored. The location information is associated with a combination of a column and a range of data values in the column. For example, the column “Stock” is divided into three ranges, which are “1 to 10”, “11 to 20”, and “21 or more”. The three ranges are allocated to the respective storage units 40 named “S26”, “S27”, and “S28”. As illustrated in FIG. 4, the division information table 500 stores notional character information such as “Kanto” and “Chubu” is stored instead of a numerical value, as a range of a value of a location.

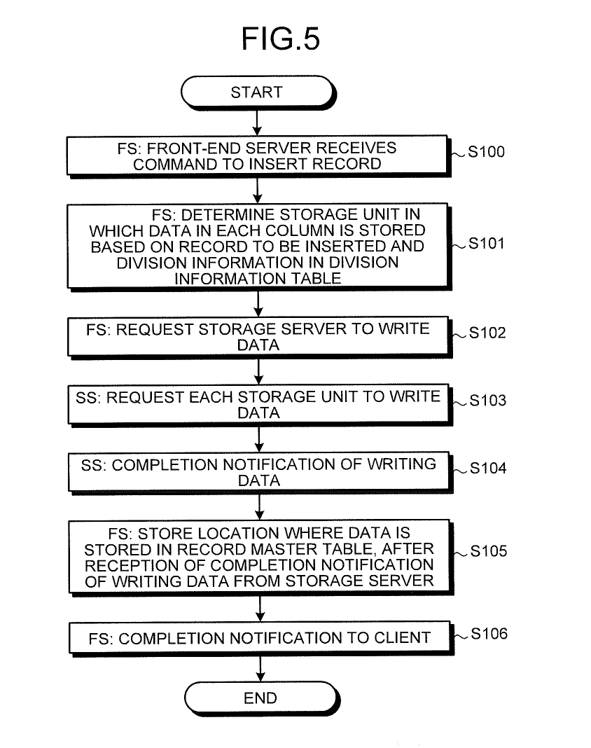

Next, a description will be given of a procedure of database processing in accordance with this embodiment. FIG. 5 is a flowchart of a process in the case where the client 30 issues a request to insert a new record. As illustrated in FIG. 5, the front-end server 10 first receives a command to insert a record from the client 30 (step S100). Subsequently, the front-end server 10 refers to data in respective columns included in the received record and the division information table 500 in order to determine which of the storage units 40 to store the respective pieces of data is stored (step S101). The front-end server 10 requests the storage server 20 to write data (step S102). The storage server 20 receives the request to write the data, and requests each of the storage units 40, which is determined by referring to the division information table 500, to write the corresponding data (step S103). In the storage server 20, the above-described dividing unit 54 divides a record such that each piece of data is stored in each of the determined storage units 40.

Subsequently, the storage server 20 outputs a notification that writing of the record is completed to the front-end server 10 (step S104). After the front-end server 10 receives the write completion notification, the front-end server 10 stores information of the location, where data of each column of the newly inserted record is stored, in the record master table 400 (step S105). Lastly, the front-end server 10 outputs a completion notification of inserting the record, to the client 30 (step S106).

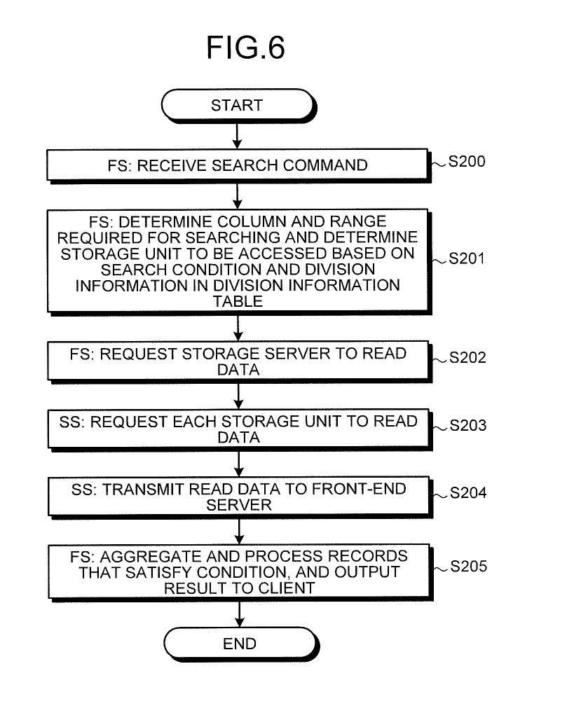

Next, a flow of processing in the case where the client 30 issues a search request will be described by referring to FIG. 6. The search request includes a request to simply see whether or not there is a record that includes specific data, and a request to obtain a sum or an average value of data in a specific column. FIG. 6 illustrates a processing in the case where data in a single column alone is referred for searching. In FIG. 6, with respect to a specific column only, the front-end server 10 first receives a search command from the client 30 (step S200). The front-end server 10 then refers to a search condition specified in the search command and information in the division information table in order to determine to which data range, a column and data required for searching belong. Then the front-end server 10 determines a physical location of the storage unit 40 to read the data (step S201).

The front-end server 10 specifies the determined storage unit 40 and then outputs a request to read data from the determined storage unit 40, to the storage server 20 (step S202). The storage server 20 requests each of the specified storage units 40 to read the data (step S203). Then, the storage server 20 transmits the read data to the front-end server 10 (step S204). Lastly, the front-end server 10 aggregates and processes the received data based on the search condition, and outputs the result to the client 30 (step S205).

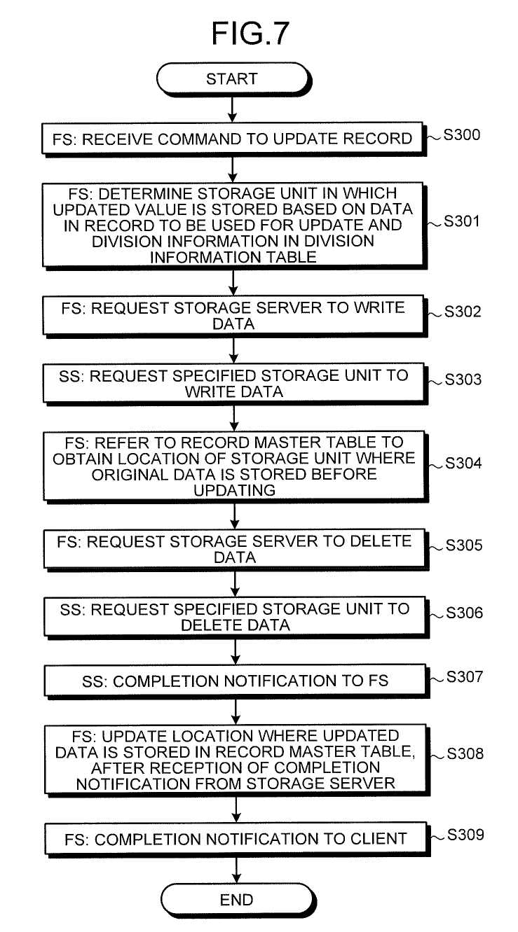

Next, a flow of processing in the case of updating a record will be described by referring to FIG. 7. In the case where a request to update a record is output from the client 30 to the front-end server 10, the request triggers the processes illustrated in FIG. 7. First, the front-end server 10 receives the command, which requests to update the record, from the client 30 (step S300). The front-end server 10 refers to the division information table 500 based on data in each column that is included in a record to be used for update, and then determines in which of the storage units 40, the updated data is written (step S301).

Then, the front-end server 10 specifies a location in the determined storage unit 40, where the data is written, and then outputs a write request to the storage server 20 (step S302). Subsequently, the storage server 20 requests the specified storage unit 40 to write the data (step S303).

In the case of updating a record, a process to delete data of the original record from the third data table 300 is also executed. First, the front-end server 10 refers to the record master table 400 based on an ID (identification information) of a record specified for updating, so as to obtain a location of the storage unit 40 where the original data is stored before updating (step S304). The front-end server 10 specifies the obtained location of the storage unit 40 where the original data is stored before updating, and then requests the storage server 20 to delete the data (step S305). The storage server 20 outputs a deletion request to delete the data in the third data table 300, which is stored in the specified storage unit 40 (step S306). After the data is deleted, the storage server 20 outputs a completion notification of deleting the data to the front-end server 10 (step S307). In the case where the front-end server 10 receives the completion notification, the front-end server 10 updates a value of the location where corresponding data is stored in the record master table 400 with a location of the updated data (step S308). Lastly, the front-end server 10 outputs a completion notification for the update request to the client 30 (step S309). The process to write data from step S301 to S304 and the process to delete data from step S305 to step S308 may be executed in parallel.

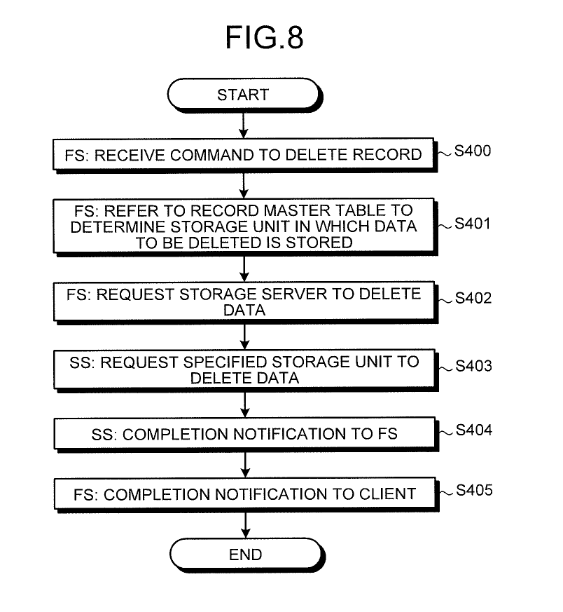

Next, a flow of processing in the case of deleting a record will be described by referring to FIG. 8. When a request to delete data is output from the client 30, the request triggers the processes illustrated in FIG. 8. As illustrated in FIG. 8, the front-end server 10 first receives the request to delete the data from the client 30 (step S400). The front-end server 10 then refers to the record master table 400 based on an ID (identification information) of a record specified for deleting, and then determines a location of the storage unit 40 where the data is stored (step S401). The front-end server 10 specifies the obtained location of the storage unit 40 where the data is stored, and then requests the storage server 20 to delete the data (step S402). The storage server 20 outputs a deletion request to delete data in the third data table 300, which is stored in the specified storage unit 40 (step S403). After the data is deleted, the storage server 20 outputs a completion notification of deleting the data to the front-end server 10 (step S404). When the front-end server 10 receives the completion notification, the front-end server 10 outputs a completion notification for the deletion request to the client 30 (step S405).

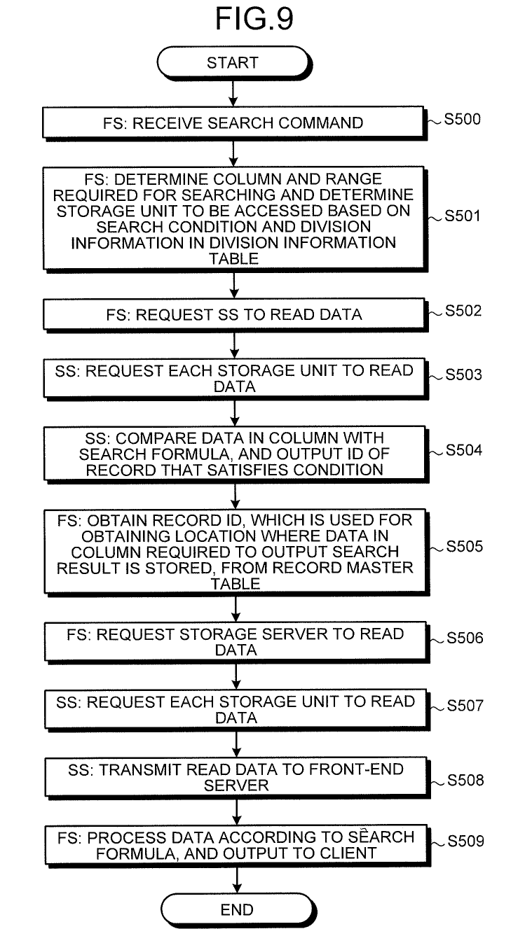

Next, a flow of processing in the case of searching over multiple columns will be described by referring to FIG. 9. This case is different from the case of searching for a single piece of data, which is illustrated in FIG. 6. In this case, it is necessary to obtain an ID from a record that satisfies a search condition in each column, and then refer to the record master table 400 to create an eventual search result. For example, this case includes a case of searching for data in multiple columns and a case where it is requested to display a column that is different from a column used for searching, as a search result.

As illustrated in FIG. 9, the front-end server 10 receives a search command from the client 30 (step S500). The front-end server 10 then refers to a search condition specified in the search command and division information in the division information table in order to determine a column needed for searching and a range to which data belongs. Then, the front-end server 10 determines a physical location of a storage unit 40 from which data is read (step S501).

The front-end server 10 specifies the determined storage unit 40 and outputs a request to read data, to the storage server 20 (step S502). The storage server 20 requests the respective specified storage units 40 to read the data (step S503). Then, the storage server 20 obtains an ID of a record corresponding to data in a column included in the search query from the read data, and then outputs the ID to the front-end server 10 (step S504). Through this step, the IDs of multiple records will be ordinarily output as a result of searching over multiple columns.

Subsequently, the front-end server 10 obtains a location of the storage unit 40, where data in a column specified as an item to be displayed as the search result is stored, from the record master table 400, using the obtained record ID as a key (step S505). The front-end server 10 then specifies the storage unit 40 that locates in the obtained location and requests the storage server 20 to read the data (step S506). The storage server 20 requests each of the specified storage units 40 to read the data (step S507). Then the storage server 20 transmits the read data to the front-end server 10 (step S508). Lastly, the front-end server 10 arranges the read data in a display format specified in the search query, and outputs the data to the client 30 (step S509).

In the database processing apparatus 1 according to the above-described embodiment, subdivided pieces of data tables are distributed, and stored in physically different storage units 40. This reduces the physical amount of data that is read in accordance with a search request. It is also possible to read data in parallel, thus improving search efficiency. Additionally, since all columns are stored in the distributed storage units 40, any of the search queries reduces degradation of search efficiency.

Adding IDs to the respective records of the third data table 300 makes it possible to respond to a search result using the ID only. This shortens transmission time between servers, thus improving search efficiency when searching over multiple servers.

In the embodiment described above, IDs are assigned to the respective third data tables 300. However, the third data tables 300 may store only a single column without the ID.

Alternatively, the process executed in the front-end server 10 may be executed in the storage server 20. For example, the example where the processes to refer to the division information table 500 and the record master table 400 are executed on the side of the front-end server 10 for searching is described above. However, processes related to the database may also be executed on the side of the storage server 20, while the front-end server 10 simply transfers a request. In this case, the division information table 500 and the record master table 400 are stored in the storage server 20. Storing a part or all of tables for managing the respective records on the side of the storage server 20 shortens the time for obtaining data in a needed column using an ID obtained as a search result, thus improving search efficiency.

Meanwhile, the database processing apparatus described above can also be put into practice with the use of a general-purpose computer device that serves as the basic hardware. That is, the dividing unit 54 and the relative units can be implemented by running computer programs in a processor installed in the computer device. At that time, the database processing apparatus can be put into practice by installing in advance the computer programs in the computer device. Alternatively, the database processing apparatus can be put into practice by storing the computer programs in a memory medium such as a compact disk read only memory (CD-ROM) or by distributing the computer programs via a network as a computer program product, and then appropriately installing the computer programs in the computer device. Moreover, the dividing unit 54 and the relative units can be implemented with the use of a memory medium such as a memory that is embedded in the computer device or attached to the computer device from outside; a hard disk; a compact disk recordable (CD-R), a compact disk rewritable (CD-RW), a digital versatile disk random access memory (DVD-RAM), and a digital versatile disk recordable (DVD-R).

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A method of processing a database, comprising:
dividing a first data table that includes records including data in a plurality of columns into a plurality of second data tables based on a predetermined criterion for dividing columns, each of the second data tables including data in at least one column;
dividing each of the second data tables into a plurality of third data tables based on a predetermined criterion for dividing data in units of a record based on the data, each of the third data tables including at least one record; and
storing the third data tables in a plurality of storage units, respectively, each of the storage units allowing the data to be read independently.

2. The method according to claim 1, wherein
the records included in the first data table include identification information for identify the respective records,
the dividing of the first data table includes dividing the first data table into the second data tables based on the criterion for dividing columns, the criterion using combinations of the identification information and one or more of the columns, and
the storing includes storing the third data table including the identification information in each record in the storage unit.

3. The method according to claim 1, wherein
the dividing of each of the second data tables includes
referring to a division information table based on data in the columns to determine the criterion for dividing data, the division information table including the criterion for dividing data and location information of the storage unit to store data corresponding to a data range in the criterion for dividing data, the criterion being associated with the location information, and
dividing each of the second data tables into the plurality of third data tables based on the determined criterion for dividing data, and
the storing includes
referring to the division information table to determine a location of the storage unit to store each of the third data tables, and
storing each of the third data tables in the storage unit at the determined location.

4. The method according to claim 3, further comprising:
generating a location information table that includes the location information of the storage unit to store each record of the third data tables, the location information being associated with the identification information.

5. The method according to claim 3, further comprising:
determining, in response to an insertion request to insert a new record, the third data table into which data in the column included in the insertion request is to be inserted, based on the criterion for dividing data; and
inserting the data in the column into the determined third data table as the new record.

6. The method according to claim 3, further comprising:
determining, in response to an update request to update the record, the third data table corresponding to data in the column included in the update request based on the criterion for dividing data;
inserting the record into the determined third data table;
determining the third data table including data in the record targeted by the update request before updating by referring to the location information table; and
deleting the record before updating from the determined third data table.

7. The method according to claim 3, further comprising:
determining, in response to an deletion request to delete the record, the third data table by referring to the location information table; and
deleting the record including the data in the record targeted by the deletion request from the determined third data table.

8. A database processing apparatus, comprising:
a logic circuit configured to
divide a first data table that includes records including data in a plurality of columns into a plurality of second data tables based on a predetermined criterion for dividing columns, each of the second data tables including data in at least one column, and
divide each of the second data tables into a plurality of third data tables based on a predetermined criterion for dividing data in units of a record based on the data, each of the third data tables including at least one record; and
a storage unit configured to store the third data tables in a plurality of storage areas, respectively, each of the storage areas allowing the data to be read independently.

9. The apparatus to claim 8, wherein
the records included in the first data table include identification information for identify the respective records,
the first data table is divided into the second data tables based on the criterion for dividing columns, the criterion using combinations of the identification information and one or more of the columns, and
the third data table including the identification information is stored in each record in the storage unit.

10. The apparatus according to claim 8, wherein
the criterion for dividing data is determined with reference to a division information table based on data in the columns, the division information table including the criterion for dividing data and location information of the storage unit to store data corresponding to a data range in the criterion for dividing data, the criterion being associated with the location information,
each of the second data tables is divided into the plurality of third data tables based on the determined criterion for dividing data,
a location of the storage unit to store each of the third data tables is determined with reference to the division information table, and
each of the third data tables is stored in the storage unit at the determined location.

11. The apparatus according to claim 10, wherein
a location information table that includes the location information of the storage unit to store each record of the third data tables is generated, the location information being associated with the identification information.

12. The apparatus according to claim 10, wherein
in response to an insertion request to insert a new record, the third data table into which data in the column included in the insertion request is to be inserted is determined based on the criterion for dividing data, and
the data in the column is inserted into the determined third data table as the new record.

13. The apparatus according to claim 10, wherein
in response to an update request to update the record, the third data table corresponding to data in the column included in the update request is determined based on the criterion for dividing data,
the record is inserted into the determined third data table
the third data table including data in the record targeted by the update request before updating is determined with reference to the location information table, and
the record before updating is deleted from the determined third data table.

14. The apparatus according to claim 10, wherein
in response to an deletion request to delete the record, the third data table is determined with reference to the location information table, and
the record including the data in the record targeted by the deletion request is deleted from the determined third data table.

15. A computer program product comprising a computer-readable medium containing a program for processing a database executed by a computer, the program causing the computer to execute:
dividing a first data table that includes records including data in a plurality of columns into a plurality of second data tables based on a predetermined criterion for dividing columns, each of the second data tables including data in at least one column;
dividing each of the second data tables into a plurality of third data tables based on a predetermined criterion for dividing data in units of a record based on the data, each of the third data tables including at least one record; and
storing the third data tables in a plurality of storage units, respectively, each of the storage units allowing the data to be read independently.

16. The computer program product according to claim 15, wherein
the records included in the first data table include identification information for identify the respective records,
the dividing of the first data table includes dividing the first data table into the second data tables based on the criterion for dividing columns, the criterion using combinations of the identification information and one or more of the columns, and
the storing includes storing the third data table including the identification information in each record in the storage unit.

17. The computer program product according to claim 15, wherein
the dividing of each of the second data tables includes
referring to a division information table based on data in the columns to determine the criterion for dividing data, the division information table including the criterion for dividing data and location information of the storage unit to store data corresponding to a data range in the criterion for dividing data, the criterion being associated with the location information, and
dividing each of the second data tables into the plurality of third data tables based on the determined criterion for dividing data, and
the storing includes
referring to the division information table to determine a location of the storage unit to store each of the third data tables, and
storing each of the third data tables in the storage unit at the determined location.

18. The computer program product according to claim 17, wherein the program causes the computer to further perform:
generating a location information table that includes the location information of the storage unit to store each record of the third data tables, the location information being associated with the identification information.

19. The computer program product according to claim 17, wherein the program causes the computer to further perform:
determining, in response to an insertion request to insert a new record, the third data table into which data in the column included in the insertion request is to be inserted, based on the criterion for dividing data; and
inserting the data in the column into the determined third data table as the new record.

20. The computer program product according to claim 17, wherein the program causes the computer to further perform:
determining, in response to an update request to update the record, the third data table corresponding to data in the column included in the update request based on the criterion for dividing data;
inserting the record into the determined third data table;
determining the third data table including data in the record targeted by the update request before updating by referring to the location information table; and
deleting the record before updating from the determined third data table.
